(19) United States
(12) Patent Application Publication
(10) Pub. No.: US 2007/0084819 A1
(43) Pub. Date: Apr. 19, 2007

(54) Disposable infant beverage container

(76) Inventor: Edward B. Fialkowski, San Diego, CA (US)

Correspondence Address: Wesley B. Ames, 7031 Los Vientos Serenos, Escondido, CA, 92029, US

(21) Appl. No.: 11/255,038

(22) Filed: Oct. 19, 2005

(51) Int. Cl. A61J 11/00; A61J 9/08; A61J 1/00; A61J 9/00

(52) U.S. Cl. 215/11.1; 215/365; 215/11.6

(57) ABSTRACT

Filled, disposable, infant beverage bottles are described that allow preparation of a beverage by adding and mixing another component or components.

### RELATED APPLICATION

Not Applicable.

### FIELD OF THE INVENTION

The present invention relates to liquid-filled beverage containers for infants.

### BACKGROUND OF THE INVENTION

The following discussion is provided solely to assist the understanding of the reader, and does not constitute an admission that any of the information discussed or references cited constitute prior art to the present invention.

For nursing infants, it is common to provide a bottle containing formula, and fitted with a nipple. In most cases, the bottle is a relatively thick, reusable bottle fitted with a reusable sealing ring and nipple assembly. It is recommended that the bottle and nipple be sterilized between uses, and further that the liquid contents, or at least water used to prepare infant formula, also be sterilized (e.g., by boiling). However, such liquid sterilization is often not performed, especially when the infant and caretaker are away from home. In addition, when formula is prepared prior to leaving the home, the prepared formula may be under warm conditions for periods of several to many hours, allowing bacteria to grow to substantial concentrations.

Certain infant bottles and bottle components have been described that are stated to be disposable.

U.S. Pat. No. 4,678,092 describes a disposable, pre-filled baby bottle that has a lower, lightweight pouch, with an upper, substantially rigid, threaded ring, where the pouch extends over the outside of the threaded portion of the ring.

U.S. Pat. No. 6,138,847 describes a disposable, filled, non-reusable baby bottle. The cap assembly is snapped onto the bottle. The nipple is initially in the inverted position, and is reversed for use by squeezing the sides of the bottle and/or by poking a finger into the inverted nipple and pulling the nipple thereby reversing the orientation of the nipple.

U.S. Pat. No. 6,737,091 concerns “A disposable baby bottle device for providing pre-packaged liquids for babies.” The device includes a container having a plurality of holes, an inner liner that is sterile and leak-proof and contains a liquid, a nipple, a protective cap, and a seal.

### SUMMARY OF THE INVENTION

The present invention provides substantial convenience and safety for infant caregivers by providing prefilled bottles that are readily used for preparing infant formula whenever needed. Thus, the invention concerns pre-filled, disposable infant beverage bottles, especially water bottles that can be opened to allow preparation of infant formula and the like, or alternatively can be used directly. The invention provides greater food safety for early infants, as well as much greater convenience for infant caretakers, while still providing the functionality of conventional re-usable infant bottles. In contrast to other described pre-filled infant bottles, the present invention provides a safe, convenient, inexpensive, and simple-to-use pre-filled bottle that still allows the infant's caregiver to prepare a desired formula solution using conventional dry infant formula mixtures.

Thus, in a first aspect, the invention concerns a pre-filled, disposable infant. beverage container, preferably sterile, that includes a disposable bottle, generally a thin-walled bottle, and a nipple assembly sealingly and removably affixed to the open end of the bottle. The bottle contains a liquid suitable for consumption by an infant; in particularly advantageous embodiments, the liquid is water, preferably purified and/or sterile water. In some embodiments, the bottle is filled to no more than 80 percent of capacity. In many cases, the nipple assembly is threaded onto the bottle. Typically, the container is produced with a safety seal, e.g., around the nipple assembly, at least where it attaches to the bottle. Typically such safety seal serves as a tamper indicator.

In many cases, the bottle is a wide-mouth bottle, e.g., with an opening of 20-50 mm diameter measured to the outside of the bottle at the opening, or 25-38, 30-38, 30-35, 31-33, 30-50, 40-50, or 40-45 mm.

In certain embodiments, the bottle is filled to no more than 80, 75, 70, 65, or 60 percent of capacity.

In particular embodiments, the bottle includes volume indicator markings showing levels for particular fill volumes. Such volume indicator markings may be molded or printed on the bottle walls (e.g., exterior of the walls), and/or on a label(s) affixed to the bottle (e.g., a wrap-around label of a glued-on label). Such measurements are typically in ounce and/or milliliter volume measurements. In particular embodiments, the volume indicator markings include markings for 4 and 6 ounces, 6 and 8 ounces, 4, 6, and 8 ounces, 4, 5, and 6 ounces, 4, 5, 6, and 7 ounces, 4, 5, 6, 7, and 8 ounces, and/or metric volumes 120 mL, 180 mL, 240 mL, 300 mL, 360 mL each of the combinations of these metric volumes taken 2, 3, or 4 at a time. Likewise, the volume indicator markings may include both ounce and mL markings, for example, 4 oz and 120 ml, 6 oz and 180 mL, 8 oz and 240 mL, and each combination of these pairs of volume markings. Also in particular embodiments, the volume indicator markings include 100 and 200 mL, 100, 200, and 300 mL, 100, 150, and 200 mL, each combination of 100, 150, 200, 250, 300, 350, and 400 mL taken two at a time, three at a time, or four at a time, or volume markings in mL that are within 10 mL of the cited ounce measurements.

In certain embodiments in which the container is filled to less than full capacity, the upper portion of the bottle or the upper portion of a label on the bottle is marked with an indication that the space is for the additional volume for addition of dry formula mix.

In certain embodiments, the container is joined as one of a set of such containers in a multi-pack, e.g., a 4-pack or 6-pack, such that the individual containers can be removed for use. The containers in the multi-pack may, for example, be joined using a wrap (e.g., shrink wrap) around all of the containers in the pack, or by use of a multi-opening stretch ring. Similar stretch rings are commonly used for soda cans, and/or beer cans. The multi-pack may be configured as a carrier pack. The containers may also be packaged in larger quantities, e.g., 12 or 24 containers, held together in a box (e.g., corrugated cardboard box) and/or plastic wrap (e.g., shrink wrap).

Also in particular embodiments, the water or other beverage is purified by filtration (which can include ultrafiltration) and/or ionic interaction, and sterilized, e.g., by one or more of filtration (for example using a filter with a rated pore size of equal to or less than 0.2, 0.1, 0.05, or 0.02 micrometers) ozone treatment, uv treatment, and gamma irradiation, e.g., post production gamma irradiation.

In certain embodiments, the bottle has a liquid capacity of 4, 6, 8, 10, or 12 ounces, or a size in a range defined by taking any two of the specified volumes as inclusive endpoints of the range.

In particular embodiments, the bottle is formed by blow molding.

In particular embodiments, the nipple assembly includes a sealing ring or collar, a nipple, and a cover plate. In such embodiments, the nipple can be installed in an inverted orientation such that the tip of the nipple points into the bottle, and is inverted for use. In other embodiments, the nipple assembly includes a sealing ring or collar, a nipple, and a seal tab. In such embodiments, the nipple is installed in an inverted orientation, and the seal tab covers and seals the opening in the sealing ring. The seal tab is then peeled away, and the nipple inverted so that the tip of the nipple protrudes though the sealing ring opening for use. In other embodiments, the nipple assembly includes a sealing ring or collar (which may be formed in one piece or fused or welded together), and the nipple is installed in a protruding orientation. The bottled is sealed at the opening, e.g., with a foil, membrane, or coated paper seal.

In certain embodiments, the bottle includes a breakable barrier. The breakable barrier forms a watertight seal within the bottle, thereby creating separate compartments.

In a related aspect, the invention concerns a method for making a pre-filled, disposable infant beverage container. The method involves filling a thin-walled bottle with potable water, preferably purified water, which can be sterile, to 60-80% of capacity; installing a nipple assembly, where the nipple assembly includes a nipple and the nipple is protected from environmental contamination following removal of the container from the conditions under which the bottle is filled and the nipple assembly installed. Preferably the filling and nipple installation are performed under controlled, clean room conditions, and the nipple is protected from environment contamination following removal of the container from the controlled, clean room conditions. The method can further involve sterilization (e.g., gamma irradiation sterilization) following the filling and nipple assembly installation.

In particular embodiments, the container is a container as described herein.

In another related aspect, the invention concerns a further method for making a disposable, pre-filled infant beverage container. The method involves purifying water from a municipal or well water supply; filling a plurality of wide-mouth, thin-walled bottles having liquid capacities between 100 and 400 mL, installing nipple assemblies on the sterile pre-filled bottles; and installing a safety seal. The method can also include sterilizing the water, bottle, and nipple assembly. Such sterilization of the water and bottle can be performed before filling the bottles with the nipple assemblies sterilized before installation (the filling and nipple assembly installation can also be carried out under sterile conditions), and/or sterilization can be performed on the filled and closed pre-filled infant beverage container.

In particular embodiments, the resulting containers are as described herein; the method also includes packaging containers in multi-packs as described herein; the method also includes packaging containers in carrier packs as described herein; the method also includes applying labels on the containers, which may be wrap-around labels; the bottles are filled to no more than 80, 75, 70, 65 or 60 percent of capacity; the bottle includes molded volume indicators; labels are installed on the bottles and the labels include volume indicators; the plurality of bottles is at least 100, 1000, 2000, 5000, or 10,000 bottles; the plurality of bottles (e.g., numbers as just listed) is filled within a period of 2 hrs, 4 hrs, 12 hrs, 24 hrs.

In another related aspect, the invention provides a method for preparing an individual infant formula serving, including placing a desired amount of a dry infant formula mix in a container as described herein, where the container contains purified and/or sterile water; placing a desired amount of dry infant formula mix in that container, and mixing the dry infant formula mix and the water to form the individual infant formula serving.

In embodiments in which a bottle with a breakable barrier is used, the method also includes breaking the barrier, thereby allowing mixing of the components in the separate compartments.

As used herein the term “bottle” refers to a container or vessel for containing a liquid that includes a base at one end, a side wall(s) extending to an opening at the end generally opposite the base. The base and walls are sufficiently rigid to allow the container to retain its shape, and thus is distinguished from a bag. The base is typically flattened so that the bottle will rest stably upright resting on the base. The bottle at the opening is configured to accept a closure, e.g., a nipple assembly. In many cases, the wall(s) is generally cylindrical, but many other shapes can be used, e.g., ovoid, square with rounded corner, and other polygons.

As used herein in connection with multi-compartment bottles, the term “breakable barrier” refers to a separation barrier in a bottle that can be physically broken or torn without substantial damage to the walls of the bottle (such as damage that causes a leak or substantially increases the risk of a leak developing), thereby creating an opening or openings in the barrier allowing mixing of components in the separate compartments.

As used in connection with the present bottles, the term “capacity” refers to the liquid volume that the bottle can hold under 1 atmosphere pressure, i.e., without stretching, compression, or at least partial collapse of the bottle structure.

As used herein in connection with the present bottles and containers, the term “disposable” indicates that an object is constructed in a manner consistent with single-use, including choice of materials, thickness of materials, and/or writing or other marking discouraging re-use. Typically, the bottle is constructed thinner than current conventional reusable baby bottles, and advantageously can be thin-walled. Advantageously the bottles can be recyclable.

The term “carrier pack” refers to a multi-pack of the present containers removably connected together, e.g., with a film collar or a shrink-wrap plastic wrap, with an opening or openings specifically adapted for insertion of a finger or fingers to allow carrying. Examples include a plurality of finger holds or a handle adapted for gripping with one hand.

As used herein in connection with the preparation of the present containers and components thereof, the term “clean-room conditions” and “controlled, clean-room conditions” refer to the component or process being held or carried out under conditions such that contamination by viable microorganisms and other contaminants is prevented to a level at least satisfying the relevant United States government standards for preparation of an infant food product, and in particular a pre-packaged infant formula, e.g., satisfying FDA Title 21 Sec. 129.20 or replacement or supplementary requirements.

As used herein, the term “infant” refers to a human infant. Typically such infant is less than 36 months of age, often less than 30, 24, 18, 12, or 6 months of age.

The term “nipple” is used conventionally to refer to a device sized and adapted for infant nursing, constructed primarily or completely of an elastomeric material, usually having a flanged region at one end, and an elongated hollow portion extending from the flanged region to a region that is closed except for a small aperture allowing slow passage of a liquid under nursing action by an infant.

As used herein, the term “nipple assembly” refers to a component or set of components that include a nipple and a collar or sealing ring that threads onto a corresponding bottle. The collar or sealing ring and the nipple may be separable, or may be joined together, and may even be formed as a single component having an elastomeric material in the nipple portion that would be contacted by an infant during use, and a rigid or semi-rigid material in the ring portion that includes threads for attaching to a bottle. The assembly may also include a cover (e.g., as part of a 3-part nipple assembly that includes a collar or sealing ring, an invertible nipple, and a removable plate or cover that blocks the central portion of the ring when the assembly is installed with the nipple in an inverted position. In such embodiments, the plate is installed under the sealing ring above the nipple. In other alternatives, the cover is removable (e.g., tear-away) without removing the sealing ring, such as a flat, tear-away sealing tab that covers an inwardly oriented nipple, or a tear-away cover that covers a nipple that is oriented outward.

In connection with the present containers, the term “pre-filled” means that the container is factory-filled to a pre-measured level with the intended liquid contents. It does not necessarily mean that the container is filled to full capacity.

As used herein in connection with water or other beverages, the term “purified” means that the liquid has been exposed to an effective level of a treatment that significantly reduces the contamination level (if present) of the beverage by microbes, particles, and/or other chemical species. Such treatments can include, for example, one or more-of reverse osmosis, filtration (e.g., activated carbon, filtration through a 2.0, 1.0, 0.5, 0.2, 0.1 micron or smaller filter, and/or ultrafiltration), high speed and/or ultracentrifugation (e.g., directly or following flocculant or other precipitation treatment), ultraviolet (uv) irradiation, ozone treatment.

As used herein in relation to nipple assemblies and bottles, the term “removably” means that a nipple assembly can be removed by hand from a bottle on which it is installed, and sealingly re-installed by hand on the same bottle at least one time by an adult of average strength and dexterity, without typically requiring any additional tools or sealants. Preferably the assembly can be removed and sealingly re-installed multiple times. Typically, but not necessarily, the nipple assembly attaches to the bottle using male threads on the outside of the portion of the bottle defining the opening, and matching female threads on the inside of the sealing ring or collar.

As used herein in connection with bottles and nipple assemblies, the term “sealingly” means that the connection between the bottle and the nipple assembly is liquid tight. Such liquid tight seal may, for example, be accomplished by squeezing an elastomeric nipple between a flange or generally flattened portion formed at the top of the bottle, by sealing between the threads of the bottle and the threads of the collar or sealing ring, by sealing between the top or upper portion of the bottle above the bottle threads and a corresponding circumferential portion of the inside of the collar or sealing ring, or by sealing using an O-ring or the like mounted inside the collar or sealing ring or on the outside of the bottle either above or below the threads.

As used herein in connection with liquids and components for the present invention, the term “sterile” refers to being sufficiently free of viable microorganisms to satisfy. government regulations for sterility for an infant food product, e.g., satisfying FDA Title 21 Sec. 165.110 VII by meeting the requirements under “Sterility Tests” <71>in the United Sates Pharmacopeia, 23^{rd} Revision, Jan. 1, 1995, or a replacement or supplementary standard. Thus, “sterile conditions” refers to conditions such that a sterile object or material subjected to such sterile conditions is also sterile following exposure to those conditions.

The phrases “suitable for consumption by an infant” and “infant-suitable” means that the material, e.g., water, is of sufficient purity and sterility to satisfy government regulatory requirements for commercial food products intended for feeding to an infant, e.g., under FDA Title 21, Sec. 165.110 (a)(3)(iii) or replacement or supplementary requirement.

In connection with the present invention bottles, the term “thin-walled” means a wall that is no more than 0.500 mm (0.020inch) in thickness. In certain embodiments, the wall is no more than 0.45, 0.40, 0.35, 0.30, 0.25, 0.20, 0.15 mm in thickness.

Additional embodiments will be apparent from the Detailed Description and from the claims.

### BRIEF DESCRIPTION OF THE DRAWINGS

FIG. 1 shows an exemplary assembled container with a 3-piece nipple assembly.

FIG. 2 shows the bottle of the container of FIG. 1.

FIG. 3 shows a nipple assembly for the container of FIG. 1.

FIG. 4 shows an alternative nipple assembly for the container of FIG. 1.

FIG. 5 shows a second exemplary bottle for a container that includes a breakable barrier creating two internal chambers in the bottle.

FIG. 6 shows an exemplary nipple assembly for the bottle of FIG. 5.

### DETAILED DESCRIPTION OF THE PREFERRED EMBODIMENTS

The present invention provides convenience and safety to infant caregivers by providing a pre-filled, disposable baby bottle adapted for preparation of baby formula as well as other beverages. The bottle is typically a wide-mouth bottle pre-filled with sterile, purified water, where the bottle includes volume markings to allow convenient preparation of a desired mix.

Thus, the container maintains the contents and the nipple in sterile conditions until the container is opened or a cover is removed. At that time, the user can add dry formula and/or other infant beverage components and mix, creating a ready-to-use infant beverage.

To provide greater assurance that the container will be used appropriately, it can be beneficial to include instructions for use on the bottle or a label attached to the bottle. Such instructions can be written and/or can be pictures illustrating the steps for appropriate use. For example, for a container containing water, there can be a plurality of pictures illustrating opening the container, adding dry formula, and mixing the formula. For embodiments in which there is a breakable barrier in the bottle, there may be a writing or picture describing or showing how to break the barrier.

In general, the bottle is formed of a waterproof plastic suitable for food container use, such as PET (PolyEthylene Terephthalate) or PLA (Polylactide).

In certain embodiments, the convenience is further enhanced by providing a pre-filled bottle that includes a breakable, leak-proof barrier, creating 2 compartments within the bottle. For example, the breakable barrier can separate the compartment containing sterile liquid, e.g., water, from a second compartment that can contain a dry material, e.g., dry formula. Typically the second compartment is located in the upper portion of the bottle adjacent the opening. A desired amount of dry formula can be placed in the dry compartment prior to use. When it is desired to mix the dry formula with the water, the barrier is broken and the bottle is shaken to create the liquid formula. The second compartment may alternatively contain a second liquid material, e.g., a liquid concentrate. For containers with such breakable barrier, the contents in the second compartment can be added at the factory or by the infant caregiver. In either case, this configuration provides enhanced convenience, e.g., by reducing the number of items that the caregiver must carry on short outings.

The breakable barrier can be of a variety of different types and can utilize various methods for breaking the barrier. For example, the barrier may be crushed by pressure on the sides of the bottle. In general such a barrier is constructed to be relatively brittle and can advantageously include one or more break or separation lines to facilitate and/or control the break(s). In other alternatives, the barrier may be broken by pushing or pulling against the barrier from either the top or the bottom. All that is required is that the break be sufficient to allow mixing of the materials in the different chambers. It is also desirable that breaking the barrier does not result in blockage of the nipple, thus, for example, the broken portions of the barrier can be retained in place, shaped such that they do not block the nipple, or accessory structures can be provided within the bottle or attached to the nipple assembly to prevent such blockage.

In embodiments in which the barrier is broken by pushing directly against the barrier, such pushing can be accomplished in various ways. For example, a separate device can be used, e.g., a spoon handle, a formula scoop handle, or other such device, or even a clean finger. In other embodiments, the barrier can be broken using a projection integrated in the container. For example, the nipple assembly may have a projection that initially extends down to near the barrier. When the nipple assembly is threaded fully onto the bottle, the projection then pushes through the barrier creating a break that allows mixing materials in the different compartments to be mixed. Alternatively the bottle can include a push rod configured such that the nipple assembly bears against the end of the push rod distal to the breakable barrier, thereby pushing it against and through the barrier. The push rod can be held in place in various ways, e.g., in a snap-in slot in the interior wall of the bottle, by passing through a pair of retaining loops that project perpendicularly from the interior wall of the bottle, or by passing through a passage or tube attached to the interior wall of the bottle.

Alternatively the projection for imparting breaking force to the breakable barrier may be attached to or be part of the breakable barrier. In this case it extends from the barrier toward the nipple assembly. When the nipple assembly is fully screwed onto the bottle, the nipple assembly bears against the distal portion of the projection, thereby transmitting force to the barrier and breaking it.

In embodiments in which the breaking force is transmitted to the barrier by threading the nipple assembly fully onto the bottle, it may be desired to provide a partial stop such that the nipple assembly encounters an intermediate position where no force is transmitted to the barrier, and a full-on position. In moving from the intermediate position to the full-on position, the breaking force is transmitted to the barrier. The intermediate stop position may be indicated by a requirement for increased effort to thread the nipple assembly further onto the bottle. Thus, for example, the top-most portion of the bottle may constitute a crush zone. At the intermediate stop position the nipple assembly bears against the top surface of the crush zone region; additional threading of the nipple assembly causes the crush zone to deform or collapse allowing the nipple assembly to reach the full-on position. Other options include the use of a breakaway tab(s) and the use of a snap-over projection. Such breakaway tabs may be placed on the bottle or on the nipple assembly. In either case, continued threading past the intermediate stop position involves breaking or at least deformation of the breakaway tabs. Use of a snap-over projection involves threading past a high friction region. For example, the bottle may have an outer circumferential ridge located below the threads or between 2 sets of threads on the neck of the bottle, and the sealing ring may have an inner circumferential ridge at its lower portion below the threads. The two ridges cause a partial interference such that it requires increased force to cause the sealing ring ridge to pass over the bottle ridge. Other structures may also be used which similarly involve an increased force to proceed from the intermediate stop position to the full-on position. The nipple assembly may, but does not necessarily, seal against the bottle when in the intermediate stop position, but does seal against the bottle in the full-on position.

In embodiments in which the barrier is broken by pulling, such pull may, for example, be accomplished by pulling on a projection attached to the barrier breaking, at least partially displacing, or removing the barrier. For example, the projection may be a thin plastic rod or strap and may have a finger loop or pull tab at the end distal from the barrier. The barrier may have a separation or tear line(s) to facilitate breaking the barrier and/or to control the location and/or extent of breakage.

In many cases, the formula or other beverage is consumed at room temperature. However, in some cases, it may be desired to warm the contents. Therefore, the invention also concerns a bottle warmer. Such a bottle warmer surrounds at least a lower portion of the bottle, and may surround most or even all of the bottle. Such warmers can be of various types, such as a battery powered warmer, or a water reservoir warmer. In either case, it can be beneficial for the warmer to be insulated to retain heat, thereby reducing the demands for a powered heater or maintaining heat in a water reservoir warmer. Advantageously, the bottle cavity of the warmer is sized to provide a slip fit (rather than a loose fit) for a container as described herein. Thus, the invention also concerns the combination of one or more of the present containers and a bottle warmer, which may have one or a plurality of bottle cavities, e.g., 2, 3, 4, 5, 6, or more.

### EXAMPLES

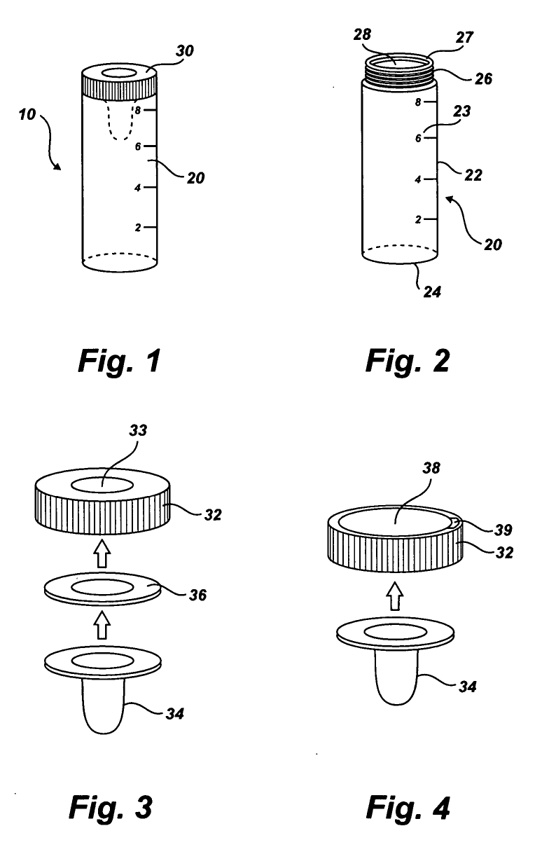

Illustrative embodiments are shown in the drawings. A first example is shown in FIGS. 1-4. Referring to FIG. 1, a single container 10 is shown, that includes a bottle 20 and a nipple assembly 30.

The exemplary bottle 20 for the container 10 is shown in FIG. 2, and includes wall 22 with volume markings 23, base 24, threads 26, sealing flange 27, and opening 28.

Referring to FIG. 3, showing the exemplary nipple assembly 30 for the container 10, the assembly includes the collar or sealing ring 32, the nipple 34, and the cap 36. For storage, the cap is placed in the opening in the collar, and the nipple is placed under the cap with the tip of the nipple oriented away from the cap. The nipple assembly is screwed onto the threads of the bottle, resulting in the nipple pointing into the bottle. For use, the nipple assembly is removed from the bottle, the cap is removed from the assembly, and the nipple is reversed. After the desired beverage components (e.g., dry formula mix) are added to the bottle, the collar with the nipple but without the cap is threaded snugly onto the bottle, resulting in a bottle ready to use.

Another embodiment of a nipple assembly suited for the bottle of FIG. 2 is illustrated in FIG. 4. Similar to the nipple assembly in FIG. 3, the nipple 34 is invertible, but the opening in the sealing ring 32 is sealed with a sealing tab 38 having a pull tab region 39, instead of a removable plate.

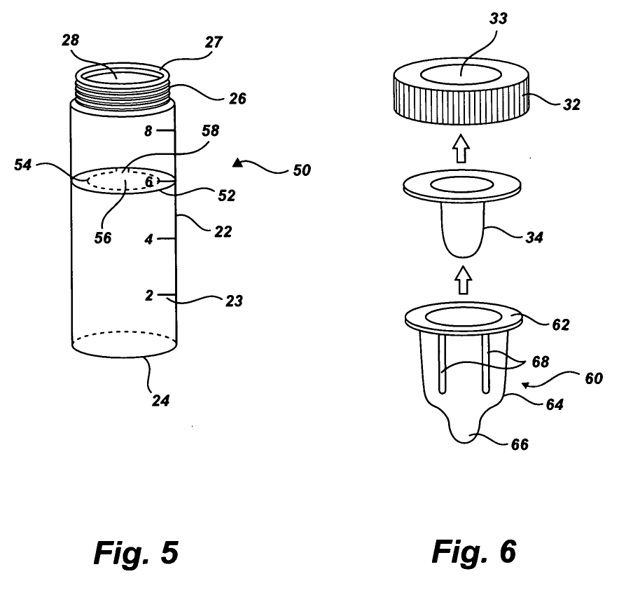

An alternative embodiment of a container is illustrated in FIGS. 5-6 that includes a breakable barrier. Referring to FIG. 5, in addition to the components illustrated for the bottle in FIG. 2, the bottle 50 includes a breakable barrier 52 that seals against or is formed with the wall 22. The breakable barrier has a separation line 54. The portion of the barrier inside the separation line is the breakaway portion 56. Upon breaking along the separation line, the breakaway portion is retained by hinge 58, thereby preventing the breakaway portion from inadvertently blocking flow through the nipple during infant nursing.

FIG. 6 shows a nipple assembly adapted for the bottle of FIG. 5 that includes a projection that will break the breakable barrier in the bottle when the nipple assembly is fully threaded onto the bottle. The nipple assembly is similar to that of FIG. 3 or 4, except that it includes extension 60, that includes a sealing flange that seals between the flange of nipple 34, and the bottle sealing flange 27. The projection has skirt 64 with one or more terminal projections 66. The skirt includes one or more slots or perforations 68 to allow liquid to flow from behind the skirt when the bottle is inverted during use by an infant.

All patents and other references cited in the specification are indicative of the level of skill of those skilled in the art to which the invention pertains, and are incorporated by reference in their entireties, including any tables and figures, to the same extent as if each reference had been incorporated by reference in its entirety individually.

One skilled in the art would readily appreciate that the present invention is well adapted to obtain the ends and advantages mentioned, as well as those inherent therein. The methods, variances, and compositions described herein as presently representative of preferred embodiments are exemplary and are not intended as limitations on the scope of the invention. Changes therein and other uses will occur to those skilled in the art, which are encompassed within the spirit of the invention, are defined by the scope of the claims.

It will be readily apparent to one skilled in the art that varying substitutions and modifications may be made to the invention disclosed herein without departing from the scope and spirit of the invention. For example, variations can be made to the materials of which the bottle and other components are formed, in the shape of the bottle and nipple, and in the sealing constructs. Thus, such additional embodiments are within the scope of the present invention and the following claims.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

In addition, where features or aspects of the invention are described in terms of Markush groups or other grouping of alternatives, those skilled in the art will recognize that the invention is also thereby described in terms of any individual member or subgroup of members of the Markush group or other group.

Also, unless indicated to the contrary, where various numerical values are provided for embodiments, additional embodiments are described by taking any 2 different values as the endpoints of a range. Such ranges are also within the scope of the described invention.

Thus, additional embodiments are within the scope of the invention and within the following claims.

1. A pre-filled, disposable infant beverage container, comprsing:
a bottle including an open end, wherein the bottle is sufficiently rigid to retain a shape;
a nipple assembly comprising a nipple, wherein said nipple assembly is removably and sealingly coupled to the open end of said bottle, wherein said nipple and said bottle combine to define a sterile internal volume;
a safety seal disposed around at least a portion of said nipple assembly that attaches to said bottle, wherein said safety seal is configured to indicate tampering;
a contamination barrier removably coupled to said nipple assembly, wherein said nipple is interposed between said barrier and said bottle and said barrier is configured to block environmental contamination of said nipple; and
infant-suitable liquid disposed in said bottle, wherein said liquid fills no more than 80% of the sterile internal volume.

2. The container of claim 1, wherein said nipple assembly comprises a collar coupled directly to said bottle, wherein a portion of said nipple is interposed between a portion of said collar and a bottle sealing flange included on said bottle.

3. The container of claim 1, wherein said liquid is water purified by one or more of activated carbon filtration, microfiltration, ultrafiltration, reverse osmosis, uv irradiation, and ozone treatment.

4. The container of claim 1, wherein said container is sterilized by gamma irradiation.

5. The container of claim 1, wherein said container is packaged in a carrier pack with at least three additional said containers.

6. The container of claim 1, wherein said bottle further comprises a breakable barrier disposed in said sterile internal volume, wherein said breakable barrier is configured to separate said liquid from an internal dry volume.

7. The container of claim 6, wherein said nipple assembly further comprises a projection that is movable to break said breakable barrier and allow mixing of said liquid and a material in said dry volume.

8. The container of claim 7, wherein said projection is moved against said separator by threading said nipple assembly onto said bottle.

9. The container of claim 7, wherein said dry volume contains an amount of a dry infant formula suitable for forming a liquid infant formula.

10. A method for making a pre-filled, disposable infant beverage bottle, comprising:
filling a bottle with infant-suitable liquid under clean-room conditions to 60-80% of capacity;
installing a removable nipple assembly under clean-room conditions, wherein said nipple assembly comprises a nipple and said nipple is protected from environmental contamination following removal of said container from said clean-room conditions.

11. The method of claim 10, wherein said bottle further comprises a breakable barrier separating said bottle into two compartments.

12. The method of claim 10, wherein said pre-filled, disposable infant beverage bottle is sterilized following said filling and installing.

13. The method of claim 12, wherein said pre-filled, disposable infant beverage bottle is sterilized by gamma irradiation.

14. A method for preparing an individual infant formula serving, comprising:
providing an infant beverage container, including a bottle that is sufficiently rigid to retain a shape; a nipple assembly comprising a nipple, wherein said nipple assembly is removably and sealingly coupled to an open end of said bottle, wherein said nipple and said bottle combine to define a sterile internal volume; a safety seal disposed around at least a portion of said nipple assembly that is configured to indicate tampering; a contamination barrier removably coupled to said nipple assembly, wherein said nipple is interposed between said barrier and said bottle and said barrier is configured to block environmental contamination of said nipple; and infant-suitable liquid disposed in said bottle and filling no more than 80% of the sterile internal volume;
placing a desired amount of a dry infant formula mix in said infant beverage container; and
mixing said dry infant formula mix and said liquid, thereby forming said individual infant formula serving.

15. The container of claim 1, further comprising a plurality of volume indicators disposed on said bottle.

16. The container of claim 1, wherein said bottle is thin-walled.

17. The container of claim 2, wherein said contamination barrier is interposed between a portion of said collar and said nipple.

18. The container of claim 2, wherein said nipple is configured to be reversible from a covered, internal orientation to an exposed, external orientation.

19. The container of claim 1, wherein said contamination barrier is coupled to an exterior surface of said nipple assembly.

20. The container of claim 19, wherein said contamination barrier is configured to be a tear-away barrier.
